(19) United States
(12) Patent Application Publication
(10) Pub. No.: US 2009/0189911 A1
(43) Pub. Date: Jul. 30, 2009

(54) DISPLAY DEVICE, DISPLAY METHOD, AND PROGRAM

(76) Inventor: Tomoyuki ONO, Saitama (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/360,788

(22) Filed: Jan. 27, 2009

(30) Foreign Application Priority Data
Jan. 30, 2008 (JP) P2008-019492

(51) Int. Cl. G06T 1/00

(52) U.S. Cl. 345/522

(57) ABSTRACT

The present invention provides a display device including an image content list holding section holding a list of a plurality of image contents, an image content obtaining section obtaining one or more image contents from the image content list held in the image content list holding section, a display screen creating section creating a display section including the one or more image contents obtained by the image content obtaining section, and a user selection request detecting section detecting a selection request from a user for an image content included in the display screen.

### CROSS REFERENCES TO RELATED APPLICATIONS

The present invention contains subject matter related to Japanese Patent Application JP 2008-19492 filed in the Japan Patent Office on Jan. 30, 2008, the entire contents of which being incorporated herein by reference.

### BACKGROUND OF THE INVENTION

1. Field of the Invention

The present invention relates to a display device, a display method and a program. More particularly, it relates to a display device, a display method and a program capable of displaying an image content.

2. Description of the Related Art

In recent years, a list of contents is being obtained from a search site as a result of search by connecting a personal computer (hereinafter referred to as a “PC”) to the Internet or the like and inputting a search keyword. After searching, a user selects a content to be displayed from the list of contents obtained as the search result to display the content. Further, also in a case where television programs are recorded in a hard disk recorder or the like and the recorded television programs are displayed in a list, a program to be played back is selected from the listed program names.

The list of contents is displayed as text data, thumbnails, or the like. When the contents are large data, such as images, audios, videos or the like, if the PC does not have enough memory capacity, not all the content data can be recorded, and also, it takes time to display the thumbnails or the like. Thus, for example, JP-A-2007-133510 discloses a technology of instantly displaying the thumbnails or the detailed metadata of the content list even with a PC with limited memory capacity.

Also, in recent years, the contents are not limited to ones whose details can be grasped based on the displayed text, such as a list of television programs, and it is becoming more common that they are images or the like distributed through the Internet, whose details are difficult to grasp based only on the text list of the contents. In such a case, a method is conceived where multiple thumbnails with file size smaller than that of contents are displayed on a display screen, and a thumbnail is selected from the displayed thumbnails.

However, even when using thumbnails, the thumbnails only extract and represent a part of the contents, and thus, there is a problem that it is difficult to accurately grasp the details of the contents. Thus, for example, JP-A-2007-96724 discloses a technology of indicating the details as accurately as possible. These technologies provide a user with rough indications so that the user can select an image content that he/she wants to display, and are useful when the selected image content is truly an image content that is worth displaying.

### SUMMARY OF THE INVENTION

However, if the displayed content is not a content that is worth displaying, there is a problem that the user has to keep selecting an image content until the desired image content is displayed. In actual case, since resources, such as memory size, display area and the like, of a PC are limited, in order to select a different image content, first, display of the unnecessary image content is removed.

Further, if the number of thumbnails that can be displayed is smaller than the number of listed image contents, the thumbnails of all the image contents cannot be displayed at one time. In such a case, after the thumbnails that can be displayed on the display screen of the PC are displayed, the user selects an image content to be displayed. However, if the image content that the user wants to display is not on the display screen, the user has to keep turning the page until the image content is found.

Basically, the step of selecting and displaying an image content has the premise that the image content the user wants to display is in the list from which an image content is to be selected. In such a system, it was enough for the user to select and display an image content. However, when the user wants to find an image content that suits his/her tastes from the contents already provided, as in the case of TV zapping, selecting and displaying an image content become bothersome and tiring.

Thus, in view of the foregoing, it is desirable to provide a new and improved display device, a display method and a program capable of sequentially replacing the image contents being displayed without a user selecting an image content that the user wants to display.

According to an embodiment of the present invention, there is provided a display device displaying a display screen including one or more image contents, including an image content list holding section holding a list of a plurality of image contents, an image content obtaining section obtaining the one or more image contents from the image content list held in the image content list holding section, a display screen creating section creating the display section including the one or more image contents obtained by the image content obtaining section and a user selection request detecting section detecting a selection request from a user for an image content included in the display screen, wherein the display screen creating section replaces, in response to the selection request from the user detected by the user selection request detecting section, the image content selected by the user with an image content different from the one or more image contents included in the display screen.

With such configuration, one or more image contents that can be displayed are obtained from the image content list holding section holding a list of a plurality of image contents, and a display screen including the image contents is created. Then, when an image content included in the display screen is selected by the user, an image content different from the image contents included in the display screen is obtained from the image content list holding section. The display screen creating section creates a display screen including, instead of the selected image content, the obtained image content, and the created display screen is displayed.

Thereby, it becomes possible to automatically display an image content different from the displayed image contents when the user merely selects an unnecessary image content. That is, the user does not have to keep selecting an unnecessary image content and selecting an image content to be displayed to have it displayed until the desired image content is found. Accordingly, the user can sequentially replace the displayed image content with another image content by merely selecting an unnecessary image content.

Further, an image content number deciding section deciding the number of image contents to be included in the display screen may be provided. The image content number deciding section may decide the number of image contents in accordance with the display capability of the display device. With such configuration, the number of the image contents to be displayed may be decided based on the state of the resources, such as limitation due to the memory capacity, the CPU load or the display area of the display device 100, or on the request from the application, such as to divide the display screen into a predetermined number of parts, and thus, it becomes possible to efficiently display the image contents while reducing the load on the display device.

Further, the image content obtaining section may obtain an image content from the image content list in accordance with the number of image contents decided by the image content number deciding section. With such configuration, the only image contents to be obtained by the image content obtaining section are the image contents to be displayed, and thus, it becomes possible to display the image contents without unnecessarily wasting memory capacity.

Further, the display screen creating section may hide, in response to the selection request from the user detected by the user selection request detection section, the image content selected by the user.

Further, the display screen creating section may decide the display position of an image content in accordance with the number of image contents to be included, and the display device may include a display number assigning section assigning a display number to the image content included in the display screen created by the display screen creating section, and a display screen management table storing, in association with each other, the display number assigned by the display number assigning section and position information of the display position of the image content decided by the display screen creating section.

Further, the image content obtaining section may decide a priority rank for an image content to be obtained in accordance with attribute information of the image content. For example, when attribute information of the image content is a collection of a user's preferences and the like, the priority rank may be decided based on the collected preference data of the user. With such configuration, it becomes possible to preferentially obtain the image content desired by the user from the image content list.

Further, the display screen creating section may create a display screen including an image content and an image content folder holding the image content, and the display device may include an image content moving section moving, in accordance with the selection request from the user detected by the user selection request detecting section, the image content selected by the user to the image content folder. With such configuration, for example, the user creates a save folder and a garbage folder, and after checking the details of a content, the user moves the image content to the save folder if the user judges the image content to be necessary or to the garbage folder if the user judges the image content to be unnecessary. Further, the user may create folders different for each degree of preference, such as 3-star, 2-star and 1-star, and after checking the details of a content, the user may move the image content to the 3-star folder if the user particularly likes the image content or, if the user does not like the image content, the user may remove the image content without moving it to any of the folders. Thereby, it becomes possible to efficiently use the image content selected and removed from the display screen.

According to another embodiment of the present invention, there is provided a display method to be executed by a display device displaying a display screen including one or more image contents, including the steps of obtaining the one or more image contents from an image content list holding section holding a list of a plurality of image contents, creating the display screen including the one or more obtained image contents, detecting a selection request from a user for an image content included in the display screen, and replacing, in response to the selection request from the user, the image content selected by the user with an image content different from the one or more image contents included in the display screen.

According to another embodiment of the present invention, there is provided a program making a computer function as a display device displaying a display screen including one or more image contents, wherein the display device includes an image content list holding section holding a list of a plurality of image contents, an image content obtaining section obtaining the one or more image contents from the image content list held in the image content list holding section, a display screen creating section creating the display section including the one or more image contents obtained by the image content obtaining section, and a user selection request detecting section detecting a selection request from a user for an image content included in the display screen, wherein the display screen creating section replaces, in response to the selection request from the user detected by the user selection request detecting section, the image content selected by the user with an image content different from the one or more image contents included in the display screen.

Such a program can have the function of each configuring element of the display device as described above executed by computer hardware resources that include, for example, a CPU, a ROM, a RAM and the like. That is, it is possible to make a computer using the program function as the above-described display device.

According to the embodiments of the present invention, the image contents being displayed can be sequentially replaced without the user selecting an image content.

### BRIEF DESCRIPTION OF THE DRAWINGS

FIG. 1 is a block diagram showing a function configuration of a display device according to an embodiment of the present invention.

FIG. 2 is a flow chart showing a display method of the display device according to the embodiment.

FIG. 3 is a flow chart describing a transition of a display screen according to the embodiment.

FIG. 4 is an explanatory diagram describing the details of the display screen according to the embodiment.

FIG. 5 is an explanatory diagram describing the display screen including an image content folder according to the embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

First, an outline of a display device according to an embodiment of the present invention will be described. In the following, a display device 100 capable of displaying one or more image contents will be described as the display device according to the embodiment of the present invention. The display device 100 can display one or more image contents. The number of image contents that can be displayed is decided based on the resources, such as memory size, display area and the like, of the display device 100. To display an image content on the display device 100, it is needed to designate a content. Generally, a method is used where the content is selected from listed image contents and is displayed. In recent years, the contents are not limited to contents whose details can be grasped based on the displayed text, such as a list of television programs, and it is becoming more common that they are images or the like distributed through the Internet, with which it is difficult to grasp the details only with the text list of the contents. Thus, efforts are often being made to make it easier to grasp the details of an image content by using thumbnails for the list of contents.

However, if the number of thumbnails that can be displayed is smaller than the number of the listed image contents, the thumbnails of all the image contents cannot be displayed at one time. Thus, when the thumbnails that can be displayed are displayed on the display screen of the display device 100, it is possible that the thumbnail of an image content that a user wants to display is not displayed on the display screen. In such a case, the user has to keep turning the page until the thumbnail of the image content that the user wants to display appears on the display screen. Further, the displayed image content may not be the image content that is truly desired by the user. This is because the accuracy of the information that can be obtained from the text list or the thumbnail of the content is limited. Accordingly, in such a case, the user has to remove the image content displayed at the time and turn the page to display another image content that the user wants to display or designate another image content that the user wants to display from the list of contents. Here, the list of contents is a list that can be obtained from a search site as a result of a search by connecting the display device 100 to the Internet or the like and with the user inputting a search keyword. The list of contents is data requiring less capacity than contents, and may be a list of text data or a thumbnail list of contents.

The user has to keep selecting and removing unnecessary contents, and has to keep selecting contents to be displayed from the list of contents and have it displayed until the desired content is found. Thus, in the light of the foregoing, the display device 100 according to the present embodiment has been achieved. According to the display device 100 according to the present embodiment, even if an image content is not selected by the user, the image contents being displayed can be sequentially replaced.

In the following, as an example of the display device 100, a PC is shown. However, the display device 100 is not limited to such, and may be, for example, an information processor such as an image processing apparatus in homes (a DVD recorder, a video cassette recorder and the like), a mobile phone, a PHS (Personal Handyphone System), a portable music playback device, a portable image processing device, a PDA (Personal Digital Assistants), a home game machine, a portable game machine, home electronics or a printer. Further, the display device 100 may be connected to a network and may obtain the list of contents from an image distribution server or the like or from the contents stored in a storage medium. In the present embodiment, the display device 100 has the list of contents already obtained by the above described method. In the following, the display device 100 will be described in detail.

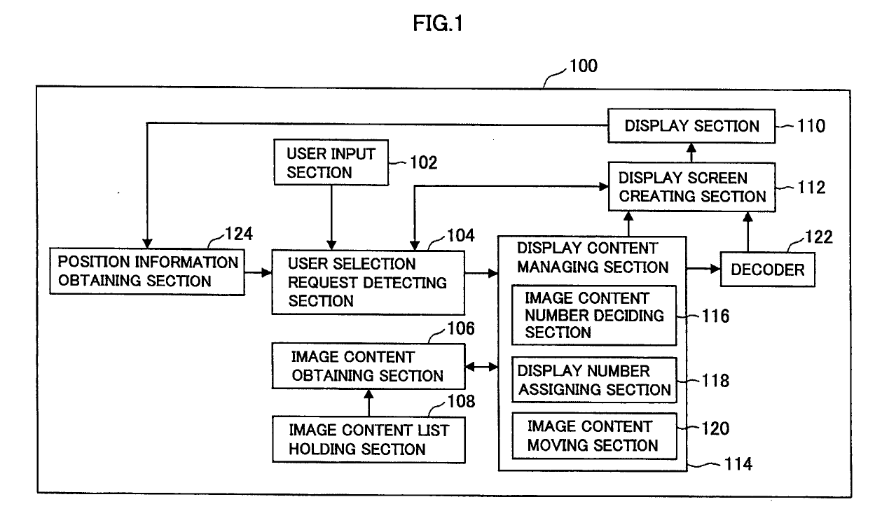

First, based on FIG. 1, the function configuration of the display device 100 will be described. FIG. 1 is a block diagram showing the function configuration of the display device 100. The display device 100 includes a user input section 102, a user selection request detecting section 104, an image content obtaining section 106, an image content list holding section 108, a display section 110, a display screen creating section 112, a display content managing section 114, an image content number deciding section 116, a display number assigning section 118, an image content moving section 120, a decoder 122, a position information obtaining section 124, and the like.

The user input section 102 is an input interface having a function of accepting an input by a user, and is configured by, for example, an input means for a user to input information, such as a mouse, a keyboard, a touch panel, a button, a microphone, a switch, a lever and the like, and an input control circuit generating an input signal based on the input from the user and outputting the same. By operating the user input section 102, the user of the display device 100 can input various data to the display device 100 or instruct the display device 100 to perform a processing operation.

The user selection request detecting section 104 has a function of detecting a selection request, from the user via the user input section 102, for an image content displayed on the display section 110. A plurality of image contents are displayed on the display section 110, and unnecessary contents are selected from the displayed image contents by the user via the user input section 102 described above. The user selection request detecting section 104 provides the display content managing section 114 with the selection information input by the user for the image contents, that is, the information as to which image content is selected by the user.

The image content list holding section 108 has a function of holding a list of a plurality of image contents, and may be, for example, a storage medium, such as a non-volatile memory such as an EEPROM (Electrically Erasable Programmable Read-Only Memory) and an EPROM (Erasable Programmable Read Only Memory), a magnetic disk such as a hard disk and a circular magnetic disk, an optical disk such as a CD-R (Compact Disc Recordable)/RW (Rewritable), a DVD-R (Digital Versatile Disc Recordable)/RW/+R/+RW/RAM(Random Access Memory) and a BD (Blu-ray Disc (registered trademark))-R/BD-RE or a MO (Magneto Optical) disk.

The image content list held by the image content list holding section 108 is a list of image contents to be displayed on the display section 110. As described above, the image content list may be obtained from an image distribution server or the like by connecting the display device 100 to a network, such as the Internet, or from the contents stored in a storage medium. The list of contents may be results of a keyword search conducted by the user or a list collected based on metadata, the metadata being the preferences and the like of the user.

The image content list may be a list of information relating to the contents to be displayed. The information is, for example, a content ID of a content, time to be displayed as a result of a search for a scene in a moving image content indicating its position from the beginning of the content, the title of the content, the recorded location of the content, and the like. The recorded location of a content may be specified by a URL (Uniform Resource Locator) indicating the location of the content on the Internet. If the location of a content is indicated by a URL, when displaying the image content, the display device 100 may be connected to the Internet to obtain the content.

The image content obtaining section 106 has a function of obtaining one or more image contents from the image content list held in the image content holding section 108. The image content obtaining section 106 may obtain the image contents from the image content list held in the image content list holding section 108 sequentially from the top of the list or randomly. The image contents may also be obtained in accordance with a preset rule. After obtaining the image content, the image content obtaining section 106 may, for example, add a flag to the image content list, or remove from the image content list, or add a number of times is obtained, so that it is possible to tell that it has been obtained. Further, the image contents may be obtained, the number of which being decided by the image content number deciding section 116 described later. The image content obtained by the image content obtaining section 106 is provided to the display content managing section 114.

The display content managing section 114 has a function of managing image contents to be displayed on the display section 110 based on the selection information input by the user for the image contents or the image contents obtained by the image content obtaining section 106. The display content managing section 114 includes the image content number deciding section 116, the display number assigning section 118, the image content moving section 120 and the like.

The image content number deciding section 116 has a function of deciding the number of image contents to be included in the display screen displayed on the display section 110. The number of image contents to be decided by the image content number deciding section 116 may be a fixed number that is preset based on the state of the resources, such as limitation due to the memory capacity, the CPU load or the display area of the display device 100, or on the request from the application, such as to divide the display screen into a predetermined number of parts. Also, the state of the resources of the display device 100 may be monitored to make the number variable with time.

The image content number deciding section 116 may instruct the image content obtaining section 106, in response to the selection request from the user detected by the user selection request detecting section 104, to obtain the necessary number of image contents. For example, when it is decided by the selection by the user that an image content is not to be included in the display screen, the image content number deciding section 116 instructs the image content obtaining section 106 to obtain another image content to be displayed instead of the image content. In response to the instruction from the image content number deciding section 116, the image content obtaining section 106 provides to the display content managing section 114 an image content that is different from the image contents already provided to the display content managing section 114.

The display number assigning section 118 has a function of assigning a display number to an image content included in the display screen created by the display screen creating section 112 described later. The display number is jointly used by the display content managing section 114 and the display screen creating section 112, and, for example, it may be assigned to the image contents provided by the image content obtaining section 106 in the obtained order. Further, the display number is a number uniquely assigned to an image content held in the image content list holding section 108 so that the image content can be identified. Thereby, it becomes possible for the display content managing section 114 and the display screen creating section 112 to judge which image content has been displayed and which image content has been removed.

The display content managing section 114 may include a display content management table (not shown) including a display number assigned by the display number assigning section 118 and the like. The content management table is configured by including, for example, the number of contents to be displayed, the display number, content information and the like. The content information is information such as the content ID of a content to be displayed, position information of the content, the off-set information and the playback time of the content and the like.

The image content moving section 120 has a function of moving, in response to the selection request from the user detected by the user selection request detecting section 104, the image content selected by the user to the image content folder. The user can select an image content, among the image contents displayed on the display section 110, not only to remove an unnecessary image content, but also, to move an image content to the image content folder where an image content is held temporarily or for a long time. For example, an image content selected by a mouse may be moved to the image content folder by dragging and dropping the same. The user may set the image content folders to be a save folder and a garbage folder or to be different according to the degree of preference, for example. The user may use the folder to temporarily store an image content when the user is not instantly playing back the content after checking the details of the content based on the image content.

For example, the user creates a save folder and a garbage folder, and after checking the details of a content, the user moves the image content to the save folder if the user judges the image content to be necessary or to the garbage folder if the user judges the image content to be unnecessary. Further, the user may create folders different for each degree of preference, such as 3-star, 2-star and 1-star, and after checking the details of a content, the user may move the image content to the 3-star folder if the user particularly likes the image content or to the 1-star folder if the user more or less likes the image content. Also, if the user does not like the image content, the user may remove the image content without moving it to any of the folders. Also, the user may create a new list of image contents for each of the folders by the operation described above without actually moving the image contents to each of the folders.

The decoder 122 has a function of decoding an image content and providing the same to the display screen creating section 112 when the image content needs to be decoded as in a case where the image content provided by the display content managing section 114 is compressed or the like.

The display screen creating section 112 has a function of creating a display screen including one of more image contents that are obtained by the image content obtaining section 106 and provided to the display content managing section 114. Further, the display screen creating section 112 has a function of replacing, in response to the selection request from the user detected by the user selection request detecting section 104, the image content selected by the user with an image content different from the one or more image contents included in the display screen. Further, the display screen creating section 112 may hide, in response to the selection request from the user detected by the user selection request detecting section 104, the image content selected by the user.

For example, when it is decided by the image content number deciding section 116 that it is possible to display 8 image contents on the display section 110, a display screen is created including 8 thumbnails provided by the display content managing section 114. Then, when the user selects an image content from the 8 image contents, a display screen is created including, instead of the selected image content, an image content provided by the display content managing section 114, which is different from the already displayed image contents.

When an image content is selected by the user, a display screen may be created including the image contents other than the selected image content. Thereby, the image content selected by the user is made hidden. Then, a display screen may be created including an image content provided by the display content managing section 114, which is different from the already displayed image contents.

Further, the display screen creating section 112 may decide the display position of an image content in accordance with the number of image contents to be displayed. For example, the display positions of image contents may be randomly changed for a case where the number of image contents to be displayed is 4 and for a case where the number of image contents to be displayed is 8. As described above, a display number is assigned to the image content included in a display screen. Accordingly, even if the display position of an image content is changed according to the number of the image contents being displayed, the content selected by the user can be specified based on the display number of the image content.

The display screen creating section 112 may include a display screen management table (not shown) managing the image content included in a display screen. The display screen management table, for example, stores, in association with each other, the display number of a content assigned by the display number assigning section 118 and position information of the display position of the image content, such as a display coordinate, a display range or the like. Further, it is configured by including the number of image contents to be displayed and the like.

Further, the display screen creating section 112 may create a display screen including an image content and an image content folder holding the image content. For example, when a displayed image content is moved to an image content folder by the image content moving section 120, the image content that is moved may be made hidden. The display screen created by the display screen creating section 112 is provided to the display section 110.

The display section 110 is configured by a display unit such as a CRT (Cathode Ray Tube) display unit, a LCD (liquid crystal display) unit, an OLED (Organic Light Emitting Display) unit or a lamp, for example. The display section 110, for example, outputs the display screen, created by the display screen creating section 112, including the image content. More specifically, the display section 110 displays various information of video data or the like that is played back in an image or a text format.

The position information obtaining section 124 has a function of obtaining position information of an image content or the like displayed on the display section 110. For example, if a display number is not assigned to a displayed image content or the display number is not provided, the content selected by the user can be detected based on position information of the image content or the like displayed on the display section 110.

Heretofore, the function configuration of the display device 100 has been described. According to the display device 100, one or more image contents that can be displayed on the display section 110 are obtained from the image content list holding section 108 holding a plurality of image contents, and a display screen including the image contents is created. Then, when an image content included in the display screen is selected by a user, an image content different from the image contents included in the display screen is obtained from the image content list holding section 108. The display screen creating section 112 creates a display screen including the obtained image content instead of the selected image content, and the created display screen is displayed on the display section 110.

Thereby, it becomes possible to automatically display an image content different from the displayed image contents when the user merely selects an unnecessary image content. That is, the user does not have to keep selecting an unnecessary image content and selecting an image content to be displayed to have it displayed until the desired image content is found. Accordingly, the user can sequentially replace a displayed image content with another image content by merely selecting an unnecessary image content.

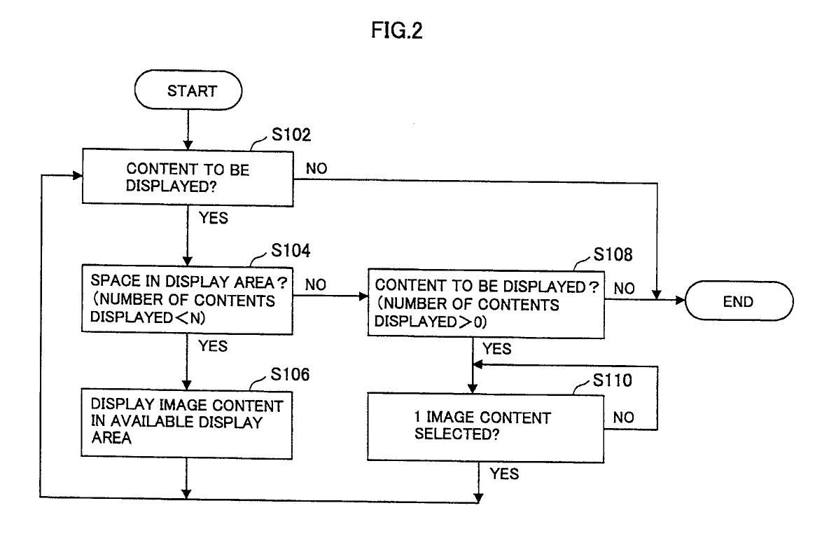

Next, a method of the display device 100 for displaying an image content according to the embodiment will be described. FIG. 2 is a flow chart showing the method of the display device 100 for displaying an image content. As shown in FIG. 2, first, it is judged whether or not there is a content to be displayed (S102). Specifically, the image content obtaining section 106 judges whether or not there is an image content in the image content list holding section 108 to be displayed on the display section 110.

When it is judged in step S102 that a content to be displayed does exist, it is judged whether or not there is a space in the display area displayed on the display section 110 (S104). For example, if the number of image contents to be displayed decided by the image content number deciding section 116 is N, it is judged whether or not the number of the image contents being displayed is smaller than N. When it is judged in step S102 that there is no content to be displayed, the process is terminated.

When it is judged in step S104 that there is a space in the display area, an image content is displayed in the available display area (S106). Then, the process of steps S102 to S106 is repeated until there is no space in the display area. With the process of steps S102 to S106, the image contents fill in the display area one by one. However, all the image contents that can be displayed in the display area can be displayed in the beginning at one time.

When it is judged in step S104 that there is no space in the display area, it is judged whether or not there still is a content to be displayed that is not yet displayed in the display area (S108). When it is judged in step S108 that there is no content to be displayed, the process is terminated. When it is judged in step S108 that there is a content to be displayed, it is judged whether or not an image content is selected by the user (S110).

The selection of an image content by the user in step S110 may be a process of making the image content hidden or a process of moving the image content to a folder prepared beforehand. When it is judged in step S110 that an image content is selected by the user, the process of steps S102 to S106 are repeated again. When an image content is not selected in step S110, the process is suspended until an image content is selected. Heretofore, the method of the display device 100 for displaying an image content has been described.

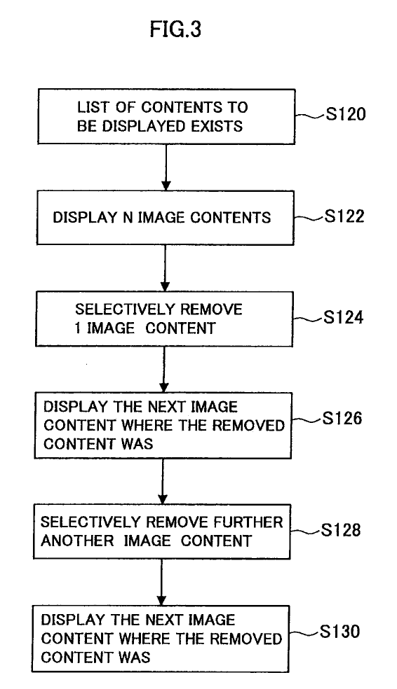

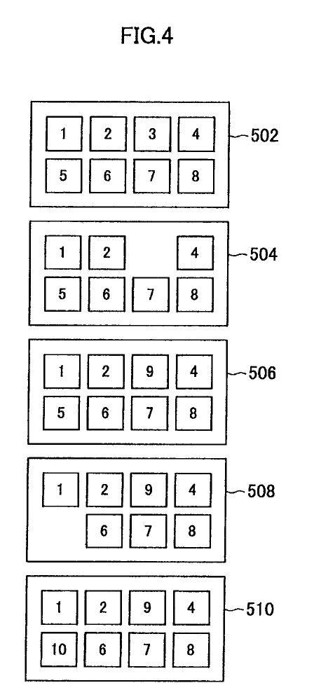

Next, based on FIGS. 3 and 4, a transition of the display screen displayed on the display section 110 will be described. FIG. 3 is a flow chart describing the transition of a display screen, and FIG. 4 is an explanatory diagram describing the details of the display screen. As shown in FIG. 3, when there is a list of contents to be displayed (S120), N contents are displayed (S122). In step S122, when N=8, for example, 8 image contents (serial numbers of the list of contents to be displayed: 1 to 8) are displayed as shown in display screen 502 in FIG. 4. As described above, the method of displaying 8 image contents included in display device 502 is decided by the display screen creating section 112.

Returning to FIG. 3, after N image contents are displayed in step S122, an image content is selected by the user and is removed (S124). When an image content is selectively removed in step S124, the image content selected by the user (serial number of the list of contents to be displayed: 3) among the 8 image contents is removed as shown in display screen 504 in FIG. 4.

Returning to FIG. 3, when an image content is selectively removed in step S124, the next image content is displayed in its place (S126). For example, when the number of contents that can be displayed is 10 and the contents are sequentially obtained from the list of contents to be displayed and displayed, in step S122, the image contents of up to serial number 8 are displayed. Then, in step S126, the image content whose serial number is 9 is displayed where the image content whose serial number is 3 that was selected and removed in step S124 was. Display screen 506 in FIG. 4 indicates, in step S126, a display screen including the image content whose serial number is 9 instead of the image content whose serial number is 3.

Returning to FIG. 3, further another image content is selectively removed by the user (S128). For example, when the image content whose serial number is 5 is selected and removed by the user, a display screen that does not include the image content whose serial number is 5 is created. Display screen 508 in FIG. 4 indicates a display screen where the image content whose serial number is 5 is selectively removed.

Returning to FIG. 3, when an image content is selectively removed in step S128, the next content is displayed in its place (S130). For example, when the image content whose serial number is 9 is displayed in step S126, the image content whose serial number is 10 following the image content whose. serial number is 9 is displayed where the image content whose serial number is 5, which was selected and removed in step S128, was. Display screen 510 in FIG. 4 indicates a display screen displaying, in step S130, the image content whose serial number is 10 instead of the image content whose serial number is 5.

In FIGS. 3 and 4, a case is described where an image content that is displayed is selectively removed by the user and is hidden from the display screen, but it is not limited to such. For example, when a displayed image content is selected by the user, the next image content may be displayed instead of the selected image content without hiding the selected image content. That is, when an image content is selected by the user, the selected image content may be replaced with the image content listed next. Heretofore, the transition of the display screen displayed on the display section 110 has been described.

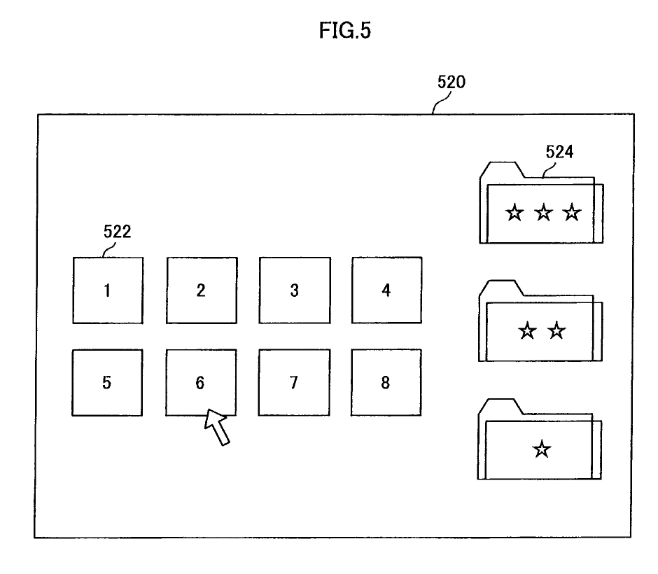

Next, based on FIG. 5, a display screen including an image content folder will be described. FIG. 5 is an explanatory diagram describing the display screen including an image content folder. As shown in FIG. 5, a display screen 520 including a plurality of image contents 522 and image content folders 524 can be created and displayed. FIG. 5 shows the display screen 520 including folders different for each degree of preference as the image content folders 524. As described above, the folders different for each degree of preference are folders with 3 stars, 2 stars and 1 star, for example. According to the details of a content, the user can move the image content to the 3-star folder if the user particularly likes the image content or to the 1-star folder if the user more or less likes the image content.

In this case also, when one of the N image contents is moved to the image content folder 524, an image content next in the list is displayed in the area from which the image content is moved and made hidden. Further, when it is judged that an image content is one that need not be held in any of the folders different for each degree of preference, the content may be selected and be made hidden. Heretofore, the display screen including the image content folder has been described.

It should be understood by those skilled in the art that various modifications, combinations, sub-combinations and alterations may occur depending on design requirements and other factors insofar as they are within the scope of the appended claims or the equivalents thereof.

What is claimed is:

1. A display device displaying a display screen including one or more image contents, comprising:
an image content list holding section holding a list of a plurality of image contents;
an image content obtaining section obtaining the one or more image contents from the image content list held in the image content list holding section;
a display screen creating section creating the display section including the one or more image contents obtained by the image content obtaining section; and
a user selection request detecting section detecting a selection request from a user for an image content included in the display screen, wherein
the display screen creating section replaces, in response to the selection request from the user detected by the user selection request detecting section, the image content selected by the user with an image content different from the one or more image contents included in the display screen.

2. The display device according to claim 1, comprising:
an image content number deciding section deciding the number of image contents to be included in the display screen.

3. The display device according to claim 2, wherein
the image content number deciding section decides the number of image contents in accordance with the display capability of the display device.

4. The display device according to claim 2, wherein
the image content obtaining section obtains an image content from the image content list in accordance with the number of image contents decided by the image content number deciding section.

5. The display device according to claim 1, wherein
the display screen creating section hides, in response to the selection request from the user detected by the user selection request detecting section, the image content selected by the user.

6. The display device according to claim 1, wherein
the display screen creating section decides the display position of an image content in accordance with the number of image contents to be included,
the display device comprising:
a display number assigning section assigning a display number to the image content included in the display screen created by the display screen creating section; and
a display screen management table storing, in association with each other, the display number assigned by the display number assigning section and position information of the display position of the image content decided by the display screen creating section.

7. The display device according to claim 1, wherein
the image content obtaining section decides a priority rank for an image content to be obtained in accordance with attribute information of the image content.

8. The display device according to claim 1, wherein
the display screen creating section creates a display screen including an image content and an image content folder holding the image content,
the display device comprising:
an image content moving section moving, in accordance with the selection request from the user detected by the user selection request detecting section, the image content selected by the user to the image content folder.

9. A display method to be executed by a display device displaying a display screen including one or more image contents, comprising the steps of:
obtaining the one or more image contents from an image content list holding section holding a list of the plurality of image contents;
creating the display screen including the one or more obtained image contents;
detecting a selection request from a user for an image content included in the display screen; and
replacing, in response to the selection request from the user, the image content selected by the user with an image content different from the one or more image contents included in the display screen.

10. A program making a computer function as a display device displaying a display screen including one or more image contents, wherein
the display device comprises:
an image content list holding section holding a list of a plurality of image contents;
an image content obtaining section obtaining the one or more image contents from the image content list held in the image content list holding section;
a display screen creating section creating the display section including the one or more image contents obtained by the image content obtaining section; and
a user selection request detecting section detecting a selection request from a user for an image content included in the display screen, wherein
the display screen creating section replaces, in response to the selection request from the user detected by the user selection request detecting section, the image content selected by the user with an image content different from the one or more image contents included in the display screen.
